(19) United States
(12) Patent Application Publication
(10) Pub. No.: US 2007/0223600 A1
(43) Pub. Date: Sep. 27, 2007

(54) Radio communication method and system for using pattern variation to identify pre-detection signal

(75) Inventors: Chao-Heng Chien, Taipei City (TW); Ying-Chun Yu, Taipei City (TW)

Correspondence Address: BACON & THOMAS, PLLC, 625 SLATERS LANE, FOURTH FLOOR, ALEXANDRIA, VA, 22314, US

(73) Assignee: Kuender Co., Ltd., Taipei City (TW)

(21) Appl. No.: 11/497,305

(22) Filed: Aug. 2, 2006

(30) Foreign Application Priority Data
Mar. 24, 2006 (TW) 095110359

(51) Int. Cl. H04L 27/00

(52) U.S. Cl. 375/259

(57) ABSTRACT

A radio communication method and system for using pattern variation to identify a pre-detection signal is provided, which uses a transmitting end and a receiving end to execute communication. The transmitting end outputs a radio signal with the pre-detection signal, which includes at least a first transmitting waveform, a second transmitting waveform and a third transmitting waveform. The cycles of the waveforms are changed according to a first predetermined relation. The receiving end is used to receive the radio signal and calculate the cycle of each receiving waveform. If the cycles of the first receiving waveform, the second receiving waveform and the third receiving waveform of the radio signal are changed according to a second predetermined relation corresponding to the first predetermined relation, the receiving waveforms are used as the pre-detection signal.

### BACKGROUND OF THE INVENTION

1. Field of the Invention

The present invention relates to radio communication technology and, more particularly, to a radio communication method and system for using pattern variation to identify a pre-detection signal.

2. Description of Related Art

Currently, a radio transmission system comprises a transmitting end and a receiving end. If the transmitting end does not transmit a radio signal to the receiving end, the receiving end will probably receive noise. In addition, if the transmitting end continues to transmit a high level or a low level radio data signal to the receiving end, the receiving end can recognize the level of the radio data signal immediately, but after a while, the radio data signal will become noise.

Therefore, in the prior art of radio communication technology, the frequency transmitted by the transmitting end will be restricted to a predetermined frequency. Before transmitting the radio data signal, the transmitting end will transmit a pre-detection signal to the receiving end for ensuring that the data signal transmitted by the transmitting end is not noise. When the receiving end receives the pre-detection signal, the receiving end will start to receive the radio data signal.

Generally, the receiving end uses time to identify the pre-detection signal. For example, if the receiving end receives three pulse signals from the transmitting end within a predetermined time, the receiving end will start to receive the radio data signal. However, mistakes are likely to occur in this method, for instance, the three pulse signals may comprise noise, and if the receiving end can not identify whether the signal is a noise or not, the receiving end will still continue to receive the data which comprises noise. In addition, not only the noise signals can cause transmission error, but also many other factors can, such as the quality of the electrical equipment, the power supply of the transmitting end and the receiving end, the transmission distance between the receiving end and the transmitting end, and the obstacles on the transmission path; under circumstances when a signal cannot be identified, error will consequently occur and cause inconvenience to users during operations.

Therefore, it is desirable to provide a radio communication method to mitigate and/or obviate the aforementioned problems.

### SUMMARY OF THE INVENTION

An object of the present invention is to provide a radio communication method and system for using pattern variation to identify a pre-detection signal, which can use the pulse width of the transmitting waveform to identify the pre-detection signal so as to prevent transmission error.

Another object of the present invention is to provide a radio communication method and system for using pattern variation to identify a pre-detection signal so as to create an adaptation radio transmission system.

In accordance with one aspect of the invention, there is provided a radio communication method for using pattern variation to identify a pre-detection signal, comprising the steps of: (A) transmitting a radio signal with a pre-detection signal by using a transmitting end, wherein the pre-detection signal includes at least a first transmitting waveform, a second transmitting waveform and a third transmitting waveform, each having a cycle, the cycle of the waveforms being changed according to a first predetermined relation; (B) receiving the radio signal, including at least a first receiving waveform, a second receiving waveform and a third receiving waveform, by using a receiving end, and calculating cycle of each receiving waveform; and (C) if the cycles of the at least first receiving waveform, the second receiving waveform, and the third receiving waveform of the received radio signal are changed according to a second predetermined relation corresponding to the first predetermined relation, the receiving waveforms are used as a pre-detection signal.

In accordance with another aspect of the invention, there is provided a radio communication system for using pattern variation to identify a pre-detection signal, comprising: a transmitting end, transmitting a radio signal with a pre-detection signal, wherein the pre-detection signal includes at least a first transmitting waveform, a second transmitting waveform and a third transmitting waveform, each having a cycle, the cycle of the waveforms being changed according to a first predetermined relation; and a receiving end for receiving the radio signal, including at least a first receiving waveform, a second receiving waveform and a third receiving waveform, and calculating cycle of each receiving waveform; wherein, if the cycles of the first receiving waveform, the second receiving waveform and the third receiving waveform of the received radio signal are changed according to a second predetermined relation corresponding to the first predetermined relation, the receiving waveforms are used as be a pre-detection signal.

Other objects, advantages, and novel features of the invention will become more apparent from the following detailed description when taken in conjunction with the accompanying drawings.

### BRIEF DESCRIPTION OF THE DRAWINGS

FIG. 1 is a functional block diagram illustrating a preferred embodiment of the present invention;

FIG. 2 is a flow chart illustrating a preferred embodiment of the present invention; and

FIG. 3 is a waveform schematic drawing showing a preferred embodiment of the present invention.

### DETAILED DESCRIPTION OF THE PREFERRED EMBODIMENT

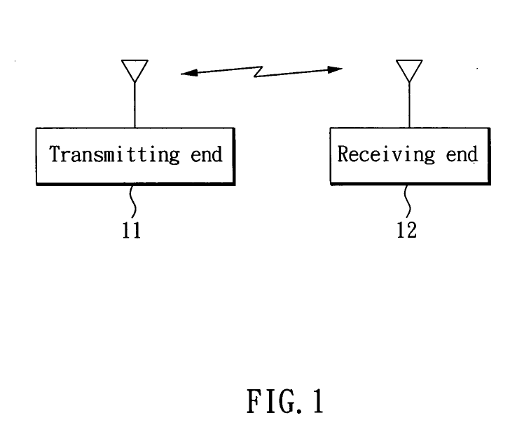

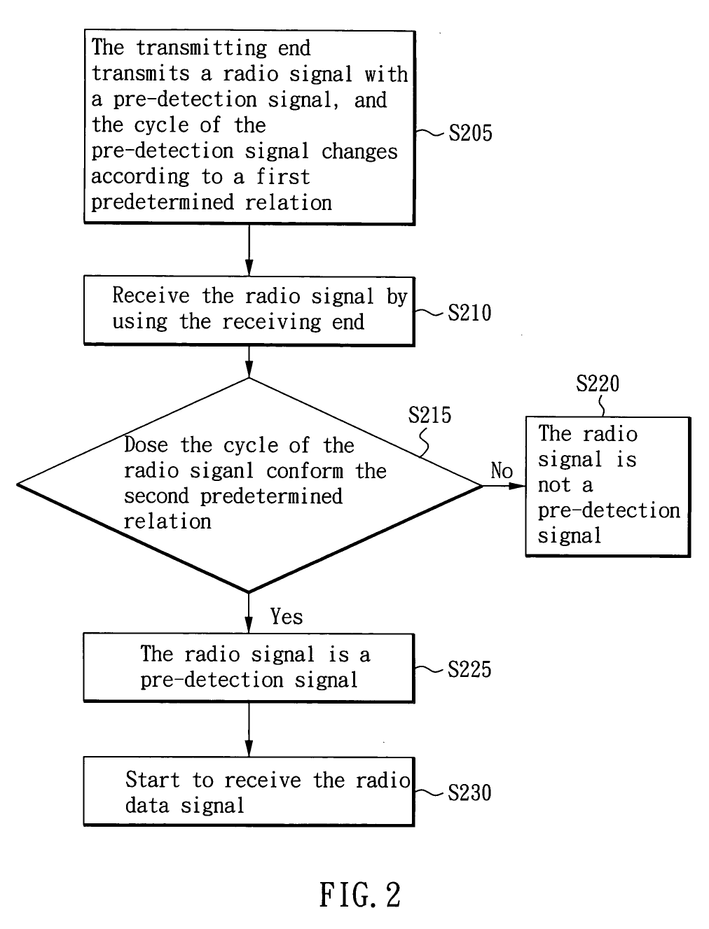

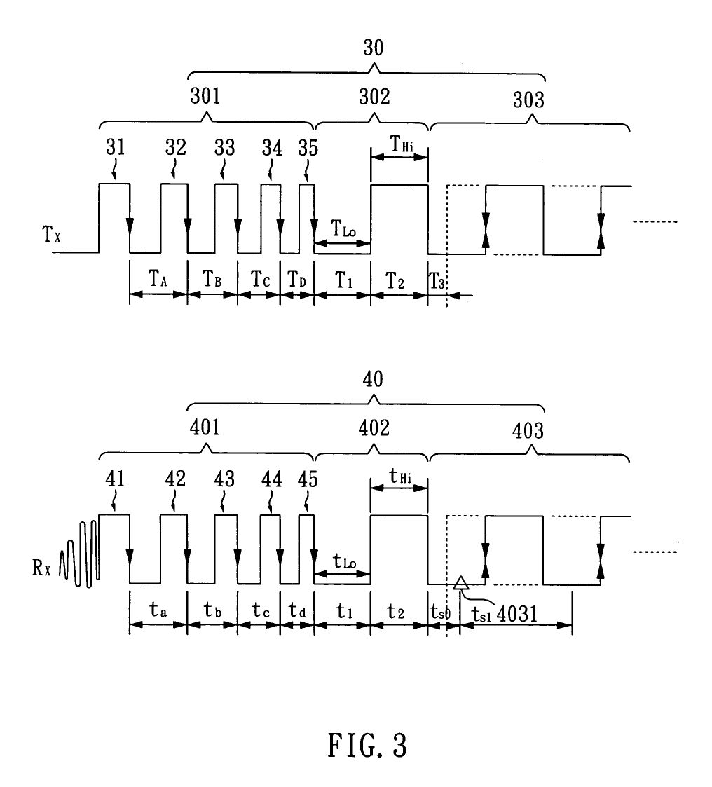

FIG. 1 is a system block diagram of a preferred embodiment of the present invention. FIG. 2 is a flowchart of a preferred embodiment of the present invention. FIG. 3 is a waveform schematic drawing of a preferred embodiment of the present invention. FIG. 1 shows a transmitting end 11 and a receiving end 12. In FIG. 3, a radio signal 30 is transmitted by the transmitting end 11, and a radio signal 40 is received by the receiving end 12, wherein the radio signal 30 further includes a pre-detection signal 301, a standard signal 302, and a radio data signal 303, and the radio signal 40 further includes a pre-detection signal 401, a standard signal 402, and a radio data signal 403. In this embodiment, the radio data signal 403 is encoded by using the Manchester encoding. Alternatively, other encoding methods can be used to encode the radio data signals.

Firstly, before transmitting the radio data signal 303 to the receiving end 12, the transmitting end 11 outputs the pre-detection signal 301 to the receiving end 12. The pre-detection signal includes a plurality of transmitting waveforms 31,32,33,34,35, and the cycles of the transmitting waveforms 31,32,33,34,35 are changed according to a first predetermined relation (Step S205). In this embodiment, the first relation is T_{A}>T_{B}>T_{C}>T_{D} and T_{A}−T_{B}<T_{B}−T_{C}<T_{C}−T_{D}, wherein T_{A}, T_{B}, T_{C}, and T_{D} respectively are the cycles of the transmitting waveforms 32,33,34,35. According to the first predetermined relation, the cycle of the transmitting waveform 32 is bigger than the cycle of the transmitting waveform 33; the cycle of the transmitting waveform 33 is bigger than the cycle of the transmitting waveform 34; the cycle of the transmitting waveform 34 is bigger than the cycle of the transmitting waveform 35, and the difference of the cycles between the transmitting waveform 32 and the transmitting waveform 33 is smaller than the difference of the cycles between the transmitting waveform 33 and the transmitting waveform 34. For other embodiments, the first relation can be T_{A}<T_{B}<T_{C}<T_{D} and T_{A}−T_{B}>T_{B}−T_{C}, wherein the T_{A}, T_{B}, T_{C}, and T_{D} respectively are the cycles of the transmitting waveforms 32,33,34,35.

Due to the receiving end 12 not being immediately able to identify whether the radio signal 40 is the pre-detection signal 401, the radio data signal 402, or a noise signal, the receiving end 12 will calculate the cycle of each transmitting waveform when the receiving end 12 receives the pre-detection signal 301 transmitted by the transmitting end 11. (Step S210)

Furthermore, the receiving end 12 will check the radio signal 40 for determining whether the cycle of the radio signal 40 conforms to the second predetermined relation, wherein the second predetermined relation corresponds to the first predetermined relation (step S215). For example, the radio signal 40 includes a plurality of receiving waveforms 41,42,43,44,45. In this embodiment, the second predetermined relation is tₐ>t_{b}>t_{c}>t_{d} and tₐ−t_{b}<t_{b}−t_{c}, wherein tₐ, tb, tc, and t_{d} respectively are the cycles of the receiving waveforms 42,43,44,45.

If the cycle of the radio signal 40 does not conform to the second predetermined relation, the receiving end will determine that the radio signal 40 is not a pre-detection signal (which may be a radio data signal or a noise signal) (Step S220).

If the cycle of the radio signal 40 conforms to the second predetermined relation, the receiving waveforms 41,42,43,44,45 are used as the pre-detection signal 401 (step S225). Therefore, the cycle of the receiving waveform 42 (tₐ) is bigger than the cycle of the receiving waveform 43 (t_{b}); the cycle of the receiving waveform 43 (t_{b}) is bigger than the cycle of the receiving waveform 44 (t_{c}); the cycle of the receiving waveform 44 (t_{c}) is bigger than the cycle of the receiving waveform 45 (t_{d}), and the difference of the cycles between the receiving waveform 42 (tₐ) and the receiving waveform 43 (t_{b}) is smaller than the difference of the cycles between the transmitting waveform 43 (t_{b}) and the transmitting waveform 45 (t_{d}).

In another embodiment, the second relation also can be tₐ<t_{b}<t_{c}<t_{d} and t_{b}−tₐ>t_{c}−t_{b}. Therefore, the cycle of the receiving waveform 42 (tₐ) is smaller than the cycle of the receiving waveform 43 (t_{b}); the cycle of the receiving waveform 43 (t_{b}) is smaller than the cycle of the receiving waveform 44 (t_{c}); the cycle of the receiving waveform 44 (t_{c}) is smaller than the cycle of the receiving waveform 45 (t_{d}), and the difference of the cycles between the receiving waveform 42 (tₐ) and the receiving waveform 43 (t_{b}) is bigger than the difference of the cycles between the transmitting waveform 43 (t_{b}) and the transmitting waveform 45 (t_{d}). At this moment, the receiving end 12 uses the receiving waveforms 41,42,43,44,45 as the pre-detection signal 401.

Furthermore, the receiving end will start to receive the radio data signal 403 after receiving the waveforms 41,42,43,44,45 which are used as the pre-detection signal 401 (step S230). Before receiving the radio data signal 403, the receiving end 12 performs sampling to the radio data signal 403. If the first data signal 4031 of the radio data signal 403 is a low level signal, the sampling time tsi is performed after receiving the standard signal. In this embodiment, the sampling time is tsi=(t1+t2)/2+(t1+t2)/4, where i is a positive integer and t1 is a pulse width of a first standard waveform of the standard signal 402, and t2 is a pulse width of a second standard waveform of the standard signal.

In other embodiments, the first data signal of the radio data signal may be a high level signal, and therefore the receiving end performs first sampling at a first sampling time ts0 after receiving the standard signal, and the first sampling time is ts0=(t2−T3 )/2+T3, where t2 is a pulse width of the second standard waveform of the standard signal, and T3 is a time delay between the standard signal and the first data signal. The receiving end also performs sampling at the other sampling time tsi=(t1+t2)/2+(t1+t2)/4, where i is a positive integer and t1 is a pulse width of a first standard waveform of the standard signal.

From the above-mentioned, it is known that this present invention uses waveform pattern variation to identify the pre-detection signal of the radio signal. Therefore, if the transmitting end uses a specially patterned waveform with a standard pulse width to be the pre-detection signal, the receiving end only needs to check the pattern of cycle and the standard pulse width of the waveform without considering the pulse width of the waveform for identifying the pre-detection signal and then uses the standard pulse width to calculate sampling time so as to create an adaptation radio transmission system.

Although the present invention has been explained in relation to its preferred embodiment, it is to be understood that many other possible modifications and variations can be made without departing from the spirit and scope of the invention as hereinafter claimed.

What is claimed is:

1. A radio communication method for using pattern variation to identify a pre-detection signal, comprising the steps of:
(A) transmitting a radio signal with a pre-detection signal by using a transmitting end, wherein the pre-detection signal includes at least a first transmitting waveform, a second transmitting waveform and a third transmitting waveform, each having a cycle, cycles of the waveforms being changed according to a first predetermined relation;
(B) receiving the radio signal, including at least a first receiving waveform, a second receiving waveform and a third receiving waveform, by using a receiving end, and calculating cycle of each receiving waveform; and
(C) if the cycles of the first receiving waveform, the second receiving waveform, and the third receiving waveform of the received radio signal are changed according to a second predetermined relation corresponding to the first predetermined relation, the receiving waveforms are used as a pre-detection signal.

2. The method as claimed in claim 1, wherein in step (A), the first predetermined relation is T_{A}>T_{B}>T_{C}, where T_{A} is the cycle of the first transmitting waveform, T_{B} is the cycle of the second transmitting waveform, and T_{c} is the cycle of the third transmitting waveform, and wherein in step (C), the second predetermined relation is Tₐ>T_{b}>T_{c}, where Tₐ is the cycle of the first receiving waveform, T_{b} is the cycle of the second receiving waveform, and T_{c} is the cycle of the third receiving waveform.

3. The method as claimed in claim 2, wherein the first predetermined relation is T_{A}>T_{B}>T_{C} and T_{A}−T_{B}<T_{B}−T_{C}, and the second predetermined relation is Tₐ>T_{b}>T_{c} and Tₐ−T_{b}<T_{b}−T_{c}.

4. The method as claimed in claim 1, wherein in the step (A), the first predetermined relation is T_{A}<T_{B}<T_{C}, where T_{A} is the cycle of the first transmitting waveform, T_{B} is the cycle of the second transmitting waveform, and T_{c} is the cycle of the third transmitting waveform, and wherein in step (C), the second predetermined relation is Tₐ<T_{b}<T_{c}, where Tₐ is the cycle of the first receiving waveform, T_{b} is the cycle of the second receiving waveform, and T_{c} is the cycle of the third receiving waveform.

5. The method as claimed in claim 4, wherein the first predetermined relation is T_{A}<T_{B}<T_{C} and T_{B}−T_{A}>T_{C}−T_{B}, and the second predetermined relation is Tₐ<T_{b}<T_{c} and T_{b}−Tₐ>T_{c}−T_{b}.

6. The method as claimed in claim 1, wherein in the step (A), the radio signal further includes a standard signal following the pre-detection signal and a plurality of data signals following the standard signal.

7. The method as claimed in claim 6, further comprising the step of:
(D) sampling the plurality of data signals received by the receiving end, and performing a first sampling at a first sampling time ts₀ after receiving the standard signal, wherein the first data signal of the plurality of data signals is a high level signal, and ts₀=(t2−T3)/2+T3, where t2 is a pulse width of a second standard waveform of the standard signal, and T3 is a time delay between the standard signal and the first data signal.

8. The method as claim in claim 7, wherein the other sampling time is tsᵢ=(t1+t2)/2+(t1+t2)/4, where i is a positive integer and t1 is a pulse width of a first standard waveform of the standard signal.

9. The method as claimed in claim 6, further comprising:
(D) sampling the plurality of data signals received by the receiving end, and performing sampling at sampling time tsᵢ after receiving the standard signal, wherein the first data signal of the plurality of data signals is low level, and tsᵢ=(t1+t2)/2+(t1+t2)/4, where t1 is a pulse width of the first standard waveform of the standard signal, and t2 is a pulse width of the second standard waveform of the standard signal.

10. The method as claimed in claim 6, wherein the plurality of data signals are encoded by Manchester Encoding.

11. A radio communication system for using pattern variation to identify pre-detection signal, comprising:
a transmitting end, transmitting a radio signal with a pre-detection signal, wherein the pre-detection signal includes at least a first transmitting waveform, a second transmitting waveform, and a third transmitting waveform, each having a cycle, the cycle of the waveforms being changed according to a first predetermined relation; and
a receiving end for receiving the radio signal, including at least a first receiving waveform, a second receiving waveform and a third receiving waveform, and calculating cycle of each receiving waveform;
wherein, if the cycles of the first receiving waveform, the second receiving waveform and the third receiving waveform of the received radio signal are changed according to a second predetermined relation corresponding to the first predetermined relation, the receiving waveforms are used as a pre-detection signal.

12. The system as claimed in claim 11, wherein the first predetermined relation is T_{A}>T_{B}>T_{C}, where T_{A} is the cycle of the first transmitting waveform, T_{B} is the cycle of the second transmitting waveform, and T_{c} is the cycle of the third transmitting waveform, and wherein in step (C), the second predetermined relation is Tₐ>T_{b}>T_{c}, where Tₐ is the cycle of the first receiving waveform, T_{b} is the cycle of the second receiving waveform, and T_{c} is the cycle of the third receiving waveform.

13. The system as claimed in claim 12, wherein the first predetermined relation is T_{A}>T_{B}>T_{C} and T_{A}−T_{B}<T_{B}−T_{C}, and the second predetermined relation is Tₐ>T_{b}>T_{c} and Tₐ−T_{b}<T_{b}−T_{c}.

14. The system as claimed in claim 11, wherein the first predetermined relation is T_{A}<T_{B}<T_{C}, where T_{A} is the cycle of the first transmitting waveform, T_{B} is the cycle of the second transmitting waveform, and T_{c} is the cycle of the third transmitting waveform, and wherein in step (C), the second predetermined relation is Tₐ<T_{b}<T_{c}, where Tₐ is the cycle of the first receiving waveform, T_{b} is the cycle of the second receiving waveform, and T_{c} is the cycle of the third receiving waveform.

15. The system as claimed in claim 14, wherein the first predetermined relation is T_{A}<T_{B}<T_{C} and T_{B}−T_{A}>T_{C}−T_{B}, and the second predetermined relation is Tₐ<T_{b}<T_{c} and T_{b}−Tₐ>T_{c}−Tb_{b}.

16. The system as claimed in claim 11, wherein the radio signal further includes a standard signal following the pre-detection signal and a plurality of data signals following the standard signal.

17. The system as claimed in claim 16, wherein the receiving end is used to sample the plurality of data signals and performs a first sampling at a first sampling time ts₀ after receiving the standard signal, wherein the first data signal of the plurality of data signals is a high level signal, and ts₀=(t2−T3)/2+T3, where t2 is a pulse width of a second standard waveform of the standard signal, and T3 is a time delay between the standard signal and the first data signal.

18. The system as claimed in claim 17, wherein the other sampling time is tsᵢ=(t1+t2)/2+(t1+t2)/4, where i is a positive integer and t1 is a pulse width of a first standard waveform of the standard signal.

19. The system as claimed in claim 16, wherein the receiving end is used to sample the plurality of data signals and perform sampling at sampling time ts i after receiving the standard signal, wherein the first data signal of the plurality of data signals is low level, and tsᵢ=(t1+t2)/2+(t1+t2)/4, where t1 is a pulse width of a first standard waveform of the standard signal, and t2 is a pulse width of a second standard waveform of the standard signal.

20. The system as claimed in claim 16, wherein the plurality of data signals are encoded by Manchester encoding.
